(19) United States
(12) Patent Application Publication
(10) Pub. No.: US 2010/0076873 A1
(43) Pub. Date: Mar. 25, 2010

(54) FEE REFUND MANAGEMENT

(75) Inventors: John David Taylor, Huntersville, NC (US); Nicholas Edward Vincent, Charlotte, NC (US); William John Carey, IV, Davidson, NC (US); Kimberly Robin Nelson, Mooresville, NC (US); Cecelia Mason Oakley Gray, Lewisville, NC (US)

Correspondence Address: Driggs, Hogg, Daugherty & Del Zoppo, 38500 Chardon Road, Willoughby Hills, OH, 44094, US

(73) Assignee: WACHOVIA CORPORATION, Charlotte, NC (US)

(21) Appl. No.: 12/235,283

(22) Filed: Sep. 22, 2008

(51) Int. Cl. G06Q 40/00; G06Q 10/00

(52) U.S. Cl. 705/30

(57) ABSTRACT

The innovation relates to a system and/or methodology for the convenient and consistent determination of fee refunds for financial products. The system provides for a fee refund component that determines a proposed fee refund based on a customer's score, and information regarding the financial institution's fee refund policies. The customer scores and fee refund policies are determined by a data analytics component, which can update the data at regular intervals or when modifications to the data occur.

### TECHNICAL FIELD

The subject specification relates generally to banking and financial institutions, and more particularly to a system and methodology for the consistent and convenient determination of courtesy fee refunds.

### BACKGROUND

Generally, in the financial industry, a ‘fee refund’ refers to a refund or the waiving of a fee charged against a customer's account. Fees can be assessed for a number of reasons, such as overdrafts or late payments. Financial institutions often offer customers fee refunds based on their relationship with financial institution and/or a desire to retain customers. In many instances, customer service representatives or financial institution employees often have the authority to make such a determination in real time by examining the customer's past dealings with the financial institution, and the circumstances of the fee assessment. Alternatively, a financial institution may refer a fee refund request to a specialized department or group. However, this often leads to inconsistent proposals, or unnecessary delay in proposing a fee refund.

The ability to make quick, consistent, and convenient decisions is of high monetary significance for financial institutions. In addition, the ability to provide consistent decisions to customers can increase customer confidence, and eliminate fee refund shopping within the same financial institution. This has been difficult in the past, because the determination to waive or refund fee can be highly subjective.

A constant balancing occurs at financial institutions between the desire to maintain an amicable relationship with the customer, and compensate the financial institution for services provided. In addition, each customer service representative or financial institution employee may evaluate the customer's relationship with the financial institution and the circumstances regarding a fee assessment differently. Unfortunately, conventional techniques of handling fee refunds are prone to human error and subjectivity.

### SUMMARY

The following discloses a simplified summary of the specification in order to provide a basic understanding of some aspects of the specification. This summary is not an extensive overview of the specification. It is intended to neither identify key or critical elements of the specification nor delineate the scope of the specification. Its sole purpose is to disclose some concepts of the specification in a simplified form as a prelude to the more detailed description that is disclosed later.

The claimed subject matter relates to a system and/or method for convenient and consistent determinations of fee refunds. In accordance with various aspects of the claimed subject matter, a data analytics component determines a customer score and/or a set of refund policies. It is to be appreciated that the customer score can be represented as a numerical value (e.g. 0 to 100), a letter grade (e.g. A, B, C, . . . , F, etc.), a level (high, medium, low, etc.), etc. within the scope and spirit of the subject innovation. Most often, the customer score is based on the relationship between the customer and a financial institution. The refund policies are often obtained from the financial institution, or based on the financial institution's policies regarding the issuance of fee refunds.

In aspects, a fee refund determination component determines a proposed fee refund based on the customer score and/or the refund policies. In addition, the fee refund component can include additional criteria, such as the customer's credit score, in its determination of the proposed fee. Customers have the option of accepting or declining the proposed fee refund. It is to be appreciated that the customer may decline a proposed fee refund to avoid affecting their customer score, or affecting their ability to attain future fee refunds.

Moreover, the fee refund determination component can update the customer score, the refund policies, and/or a customer's account information based on their disposition regarding the proposed fee refund. In addition, the data analytics component can update customer scores and refund policies at a predetermined interval or as the data changes.

The following description and the annexed drawings set forth certain illustrative aspects of the specification. These aspects are indicative, however, of but a few of the various ways in which the principles of the specification can be employed. Other advantages and novel features of the specification will become apparent from the following detailed description of the specification when considered in conjunction with the drawings.

### BRIEF DESCRIPTION OF THE DRAWINGS

FIG. 1 illustrates an example general component block diagram for a fee refund management system in accordance with an aspect of the subject specification.

FIG. 2 illustrates an example general component block diagram of a fee refund management system in accordance with an aspect of the subject specification.

FIG. 3 is a general component block diagram illustrating an example set of subcomponents for a fee refund determination component in accordance with an aspect of the subject specification.

FIG. 4 is a general component block diagram illustrating an example set of subcomponents for a data analytics component in accordance with an aspect of the subject specification.

FIG. 5 is a general component block diagram illustrating an example set of subcomponents for a user interface component in accordance with an aspect of the subject specification.

FIG. 6 is a general component block diagram illustrating an example set of subcomponents for a data store in accordance with an aspect of the subject specification.

FIG. 7 illustrates an example schematic block diagram for a fee refund management system in accordance with an aspect of the subject specification.

FIG. 8 illustrates a representative graphical user interface in accordance with an aspect of the subject specification.

FIG. 9 illustrates an example methodology for providing fee refund determinations in accordance with an aspect of the subject specification.

FIG. 10 illustrates a system that employs an artificial intelligence component that facilitates automating one, or more features in accordance with the subject specification.

FIG. 11 is a schematic block diagram illustrating a suitable operating environment in accordance with an aspect of the subject specification.

FIG. 12 is a schematic block diagram of a sample-computing environment with which the subject innovation can interact.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It can be evident, however, that the claimed subject matter can be practiced without these specific details. In other instances, well-known structures and devices are shown in block diagram form in order to facilitate describing the claimed subject matter.

As used in this application, the terms “component,” “module,” “system”, “interface”, or the like are generally intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. As another example, an interface can include I/O components as well as associated processor, application, and/or API components. As used in this application, the terms “product” and “service” are to have reciprocal descriptions. For example, if a product is described as having certain attributes such as a price, then it is to be appreciated that a service can inherently have the same and/or similar capabilities unless stated otherwise.

Furthermore, the claimed subject matter can be implemented as a method, apparatus, or article of manufacture using standard programming and/or engineering techniques to produce software, firmware, hardware, or any combination thereof to control a computer to implement the disclosed subject matter. The term ‘article of manufacture’ as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications can be made to this configuration without departing from the scope or spirit of the claimed subject matter.

As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

For purposes of simplicity of explanation, methodologies that can be implemented in accordance with the disclosed subject matter were shown and described as a series of blocks. However, it is to be understood and appreciated that the claimed subject matter is not limited by the order of the blocks, as some blocks can occur in different orders and/or concurrently with other blocks from what is depicted and described herein. Moreover, not all illustrated blocks can be required to implement the methodologies described hereinafter. Additionally, it should be further appreciated that the methodologies disclosed throughout this specification are capable of being stored on an article of manufacture to facilitate transporting and transferring such methodologies to computers.

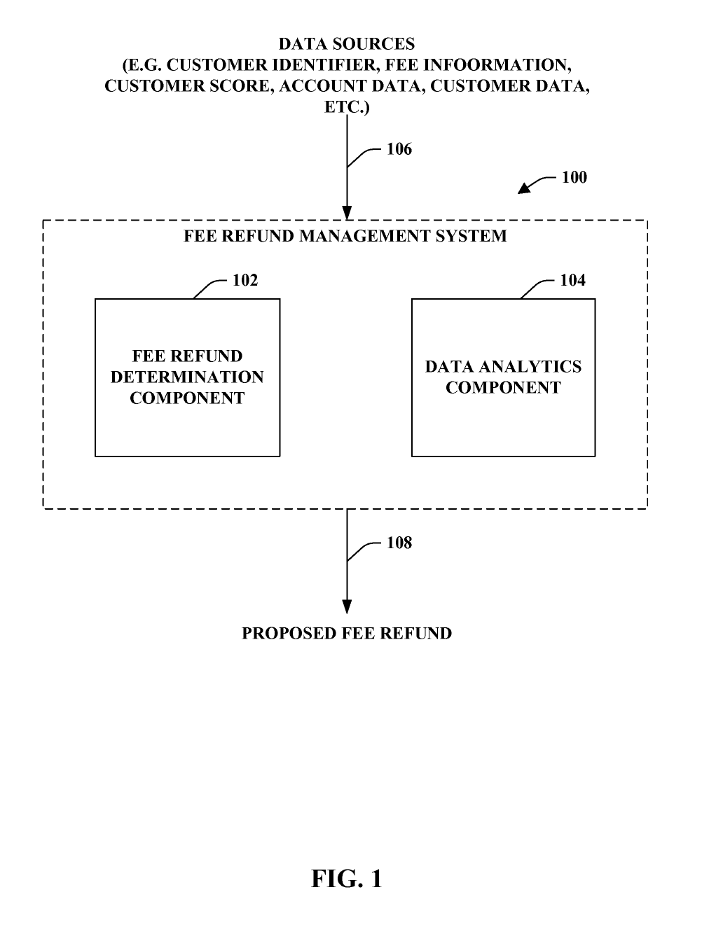

Referring initially to FIG. 1, an example block diagram of a fee refund system 100 is shown in accordance with an aspect of the subject innovation. The system includes a fee refund determination component 102, a data analytics component 104, one or more data sources 106, and an output 108.

The fee refund component 102 determines a permissible fee refund amount for a fee assessed against a customer's account (e.g. deposit account, credit account, investment account, etc.), wherein the fee refund can be a full or partial refund of the fee amount. The fee refund can be represented as a dollar amount, a percentage, and so forth. The fee refund determination component 102 can determine the fee refund based on a customer score, a set of account data (e.g. customer score, type of accounts, value of accounts, transaction history, etc.), a set of customer data, such as a relationship between the customer and a financial institution, one or more circumstances of the fee assessment (e.g. reason), and/or a customer's credit rating. In addition, the fee refund determination component 102 can determine the fee refund as a function of one or more business objectives of the financial institution, such as retaining the customer's business or a set of policies regarding fee refunds. The customer data, account data, and/or business objectives can be acquired via the data sources 106 (discussed infra).

For instance, an existing customer of a financial institution may desire a refund for an overdraft fee assessed against their checking account. In this case, the fee refund determination component 102 can determine whether the customer qualifies for a fee refund based on the relationship between the customer and the financial institution (e.g. customer data), as well as the financial institution's business objectives. If the customer does not qualify for a fee refund, or if it would not be advantageous for the financial institution to offer a fee refund, then the fee refund determination component 102 can return a null value or a permissible refund amount of zero via the output 108 (discussed infra). Alternatively, if the customer qualifies for a fee refund, then the fee refund determination component 102 can determine a permissible refund amount based on the relationship with the financial institution, and/or the business objectives of the financial institution.

The data analytics component 104 can analyze the customer data, account data, and/or business objectives and generate one or more customer scores. The customer score is essentially a confidence factor assigned to a customer based on their specific customer data, such as prior fee refunds, account types, length of patronage, etc. The customer score can be represented as a percentage, a number on a predefined scale (e.g. 0 to 100), a letter grade (A, B, C, . . . , F), a level (e.g. low, medium, high), and so forth. In addition, the data analytics component 104 can analyze data regarding the business objectives, such as fee refund policies.

The data sources 106 can include explicit user inputs (e.g., configuration selections, question/answer) such as from touch screen selections, keyboard, mouse, speech, scanner and so forth. In addition, the data sources 106 can include but are not limited to one or more data stores, and/or one or more applications. The application can be integrated with the fee refund management system 100 or can be a standalone application or applet. For instance, the customer data and/or account data can be obtained from a database maintained by the financial institution.

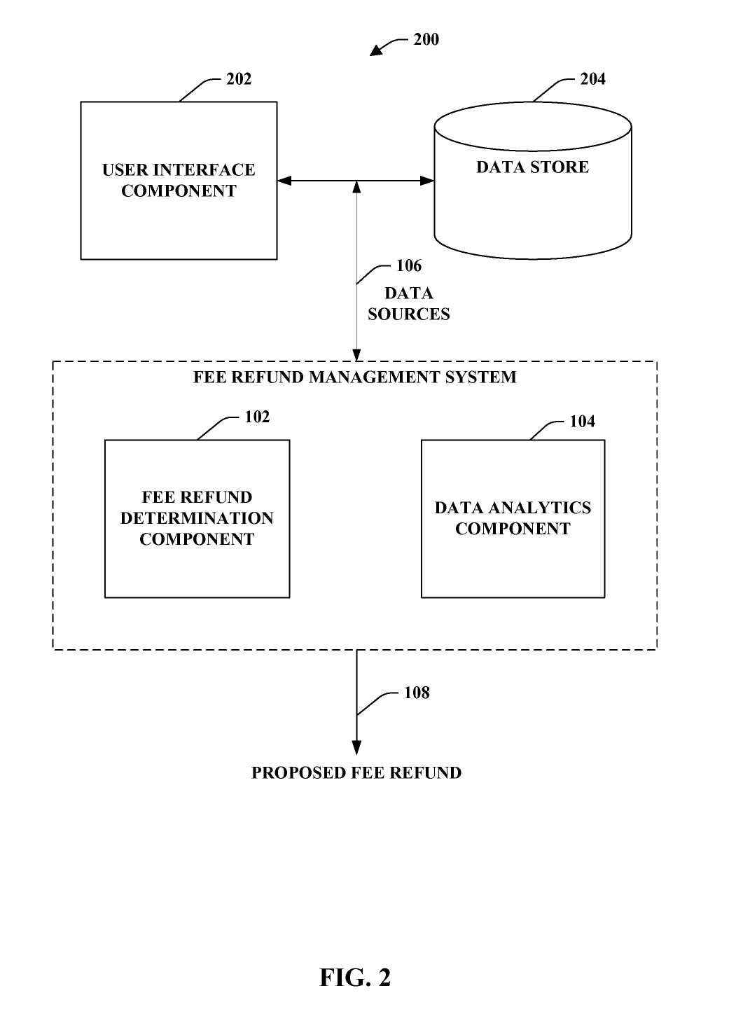

FIG. 2 is an example block diagram of a fee refund system 200 shown in accordance with an aspect of the subject innovation. The system includes a fee refund determination component 102, a data analytics component 104, one or more data sources 106, and an output 108. As discussed supra, the fee refund component 102 can determine a permissible fee refund amount for a fee assessed against a customer's account based on a customer score (e.g. customer rating), a set of account data (e.g. type of accounts, value of accounts, transaction history, etc.), a set of customer data, such as a relationship between the customer and a financial institution, one or more circumstances of the fee assessment (e.g. reason), and/or a customer's credit rating. In addition, the fee refund determination component 102 can determine the fee refund as a function of one or more business objectives of the financial institution, such as retaining the customer's business or a set of policies regarding fee refunds. The customer score can be determined by the data analytics component 104.

The data analytics component 104 can analyze the customer data, account data, and/or business objectives and generate one or more customer scores. The customer score is essentially a confidence factor assigned to a customer and can be represented as a percentage, a number on a predefined scale, a letter grade, etc. Furthermore, the data analytics component 104 can update the customer score and/or business objectives at a scheduled time interval (e.g. daily, weekly, monthly, yearly, etc.), or as a function of changes to the customer data or the business objectives. For instance, the data analytics component 104 can update a customer score on a daily basis to reflect changes in the customer's customer data. Additionally or alternatively, the data analytics component 104 can update the customer score or business objectives as a result of changes to the data, such as a customer opening an additional account or a shift in the fee refund policies.

The customer data, account data, and/or business objectives can be acquired via the data sources 106. The data sources 106 can include but are not limited to a user interface component 202, and a data store 204. The user interface component 202 can expose one or more interfaces enabling user interaction with the fee refund determination component 102, the data analytics component 104, and/or the data store 204. For instance, the user interface component 202 can provide an interface that allows a user to request a fee refund for a customer. The user can enter a customer identification (e.g. account number, social security number, identification number, etc.), wherein the customer identification will be used by the fee refund determination component 102 to facilitate query of the data store 204 for the customer's account data, customer data, and/or the financial institution's business objectives.

The user interface component 202 can obtain virtually any inputs type, including but limited to explicit user inputs (e.g., configuration selections, question/answer) such as from touch screen selections, keyboard, mouse, speech, scanner and so forth. In addition, the user interface component 202 can provide one or more interfaces that display a proposed fee refund 108 (discussed infra), and can enable a user to enter a disposition (e.g. accept, or decline) regarding the proposed fee refund. A customer may elect to decline a proposed fee refund for a variety of reasons. For instance, a customer may decline a proposed fee refund that they consider to be inadequate, or the customer may decline a proposed fee refund to avoid affecting their customer score. The user interface component 202 may be a form on a web site wherein users access the form via a web browser on a personal computer, mobile device, and so forth. It is also to be appreciated that the user interface component 202 may be a standalone application, applet or widget executing on a personal computer or mobile device.

For instance, Courtney is a customer of Wachovia Bank. Courtney may desire a fee refund for an overdraft fee assessed against her checking accounting. A qualified Wachovia employee can request a fee refund for Courtney via the user interface component 202. The fee refund component 202 can facilitate query of the data store 204 to obtain Courtney's customer score, account data, and/or Wachovia's financial objectives. The fee refund determination component 102 can determine a fee refund, for example, of 35% for Courtney based on her account data, customer data, and Wachovia's fee refund policies. Alternatively, if Courtney does not qualify for a fee refund, or if it would not be advantageous for the financial institution to offer a fee refund, then the fee refund determination component 102 can return a null value or a permissible refund amount of zero. The Wachovia employee can review the proposed fee refund via the interface component 202, and offer Courtney a refund less than or equal to the proposed fee refund. Courtney may decide to decline the offered fee refund in order to avoid making herself ineligible for future fee refunds, because accepting the proposed fee refund may lower her customer score (discussed supra). The Wachovia employee can enter Courtney's disposition (e.g. accept or decline) regarding the offered refund via the user interface component 202.

The fee refund determination component 102 can update the customer data with the customer's disposition. For instance, if the customer accepts the proposed fee refund, then the fee refund determination component 102 can apply the refund toward the desired account. Alternatively, if the customer declines the proposed refund, then the customer data can be updated with the proposed refund and non-acceptance. Updating the customer data to reflect the customer's disposition of a proposed fee refund can prevent inconsistent refund offers, and refund shopping by the customer. For instance, if a customer is unsatisfied with a proposed refund they received at a branch, the customer might call a customer service representative for the financial institution. However, the customer data now reflects the fee refund proposed by the branch, and therefore prevents the customer service representative from offering a different (e.g. more favorable) refund.

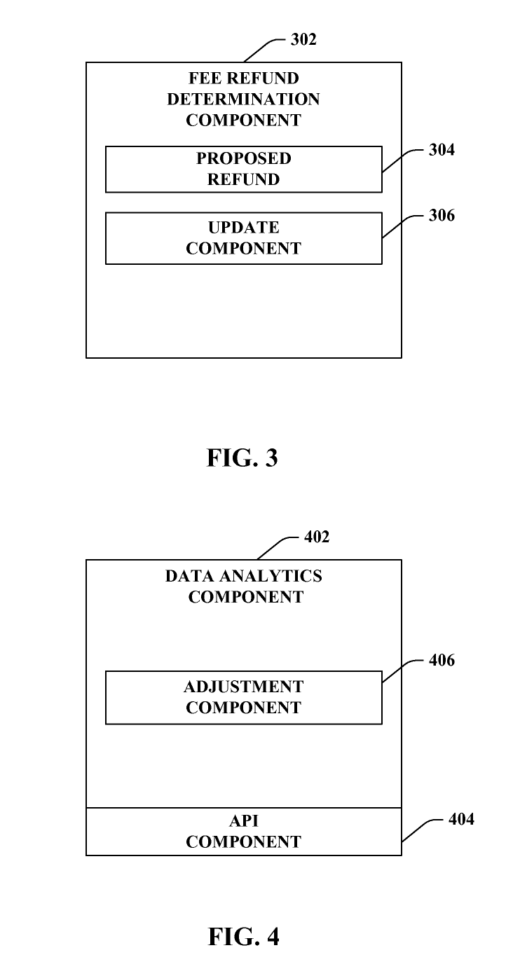

FIG. 3 is an example block diagram of a fee refund determination component 302 illustrating the subcomponents in accordance with an aspect of the subject innovation. The fee refund determination component 302 includes a query component 304, and an update component 306. As discussed supra, the fee refund determination component 302 determines a proposed full or partial refund fee refund for one or more fees assessed against a financial account (e.g. deposit account, credit account, investment account, etc.),based mostly on a customer score, account data, customer data, and/or a customer's credit rating. In addition, the fee refund determination component 302 can determine the fee refund based on a set of refund policies and/or a set of business objectives for the financial institution.

The query component 304 can facilitate query of one or more data sources (e.g. data store, database, application, etc.) to obtain the customer's account data, one or more customer scores, and/or a set of refund policies. The account data can include account types, contact information, length of patronage, value of accounts, fees issued (e.g. late fees, overdraft fees, etc.), prior fee refund request, and so forth (e.g. data reflecting a customer's relationship with a financial institution). As noted previously, the customer scores are essentially confidence ratings assigned to customers based on their specific customer data, such as account data. The refund policies 210 can include one or more policies regarding the financial institution's fee refund procedure. For instance, the refund policies can contain a policy prohibiting fee refunds for customer accounts less than 60 days old.

The update component 306 can update the account data, the customer scores, and a set of tracking data with a customer's disposition regarding a proposed fee refund. For instance, when a customer accepts a proposed fee refund for a checking account, the update component can apply the proposed refund to the customer's checking account. Alternatively, if the customer declines the proposed fee refund, then the customer's account data and the tracking data can be updated with the proposed refund and non-acceptance. As noted previously, updating the account data to reflect the customer's disposition of a proposed fee refund can prevent inconsistent refund offers, and refund shopping by the customer. In addition, updating the tracking data can enable data tracking regarding fee refund dispositions offered by a financial institution, a branch, a set of branches, and so forth. Moreover, the updated tracking data can be used by the data analytics component to determine the refund policies (discussed infra).

FIG. 4 is an example block diagram of a data analytics component 402 illustrating the subcomponents in accordance with an aspect of the subject innovation. The data analytics component 402 can analyze a customer's account data, customer data, and/or credit score and determine one or more customer scores. For instance, the data analytics component 402 can determine the customer score 208 based on the customer's account types, length of patronage, value of accounts, fees issued (e.g. late fees, overdraft fees, etc.), prior fee refund request, and so forth. In addition, the data analytics component 402 can determine, update, or otherwise modify a financial institution's refund policies. For instance, the data analytics component 402 can update a set of refund policies based on a set of tracking data and/or a set of external data (discussed infra).

The data analytics component 402 includes an application programming interface component (hereinafter API component) 404 that includes any suitable and/or necessary adapters, connectors, channels, communication paths, etc. to integrate the data analytics component 402 into virtually any operating and/or database system(s). Moreover, the API component 404 can provide various adapters, connectors, channels, communication paths, etc., that provide for interaction with the data analytics component 402. The API component 404 enables the data analytics component 402 to obtain data from most any of a plurality of external sources (e.g. applications, websites, databases, etc.). For instance, the data analytics component 402 can obtain data relating to the refund policies 210 from an Internet source (e.g. website), or a database maintained by the financial institution. Additionally or alternatively, the data analytics component 402 can obtain the data via explicit user input (discussed supra). The data can be stored in a data store, and included in the determination of one or more refund policies.

The data analytics component 402 can further include an adjustment component 406. The adjustment component 406 can update, modify, or otherwise adjust the customer scores, and the refund policies, based on the tracking data, including data obtained by the data analytics component 402. The adjustment component 406 can update the customers scores and refund policies at a scheduled interval (e.g. daily, weekly, monthly, etc.). Additionally or alternatively, the adjustment component 406 can update the customer scores and refund policies upon the occurrence of an event (e.g. modifications to the account data 206 and/or tracking data 212, etc.).

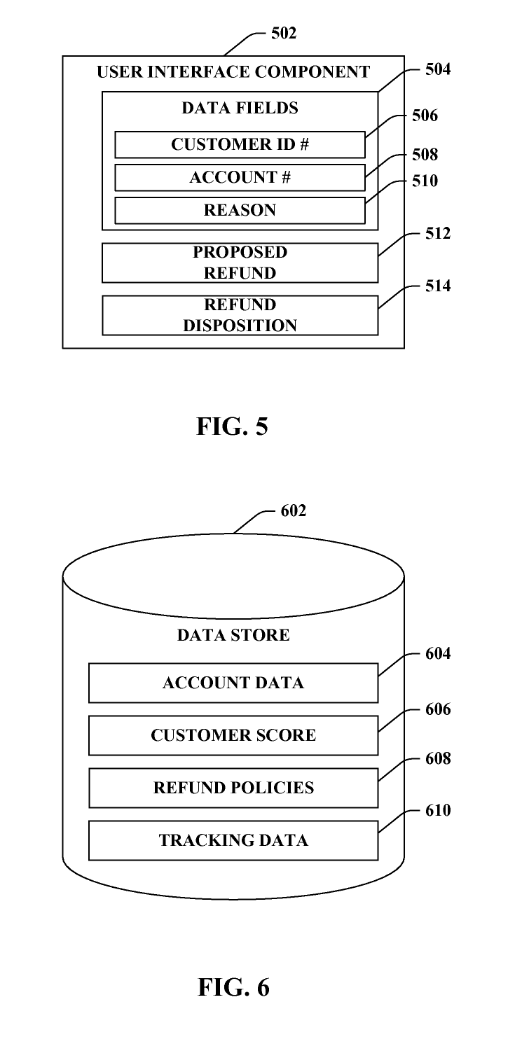

FIG. 5 is an example block diagram of a user interface component 502 illustrating the subcomponents in accordance with an aspect of the subject innovation. As noted supra, the user interface component 502 can expose one or more interfaces enabling user interaction with the fee refund determination component 302 (see FIG. 3), the data analytics component 402 (see FIG. 4), and/or a data store 602 (see FIG. 6). The user interface component 502 includes a set of data fields 504. The data fields 504 can include but are not limited to a customer identification number field 506, an account number field 508, and a reason field 510. The data fields 504 can be entered, determined, set or otherwise configured via a set of inputs. As noted previously, the inputs can be obtained via most any of plurality of input means, including explicit user inputs (e.g., configuration selections, question/answer) such as from touch screen selections, keyboard, mouse, speech, scanner and so forth. The user interface 502 may be a form on a web site wherein users access the form via a web browser on a personal computer, mobile device, and so forth. It is also to be appreciated that the user interface 502 may be a standalone application, applet or widget executing on a personal computer or mobile device.

In operation, a user (e.g. banker, customer service agent, etc.) can enter one or more data fields 504 to request a fee refund for a customer. The fee refund determination component 302 (see FIG. 3) can facilitate query of one or more data sources (e.g. data store, application, etc.) for account data, customer data, one or more customer scores, and/or refund policies relating to the data fields 504. The fee refund determination component 302 generates a permissible fee refund based on the foregoing. For example, the proposed fee refund can be determined using the equation:

Refund=F(C, P)

where C is the customer score and P is the refund policies. The permissible fee refund is returned to the user for review via a proposed refund field 512 in the user interface 502. The user interface 502 can expose one or more interfaces to display the proposed refund field 512, which notifies the user of the permissible fee refund determined by the fee refund determination component 302 (see FIG. 3). The user can enter, determine, or otherwise set a customer's disposition (e.g. accept or decline) regarding the proposed fee refund via a refund disposition field 514. In operation, the disposition can be communicated to the fee refund determination component 302, which can update the customer's account data, customer score, one or more refund policies, and/or a set of tracking data based on the customer's disposition.

Additionally or alternatively, a user can input a circumstance regarding the fee assessment via the reason field 510, and the fee refund determination component 302 can determine a proposed fee refund based on the customer's account data, customer score, one or more refund policies using the reason 510. For example, the proposed fee refund 512 can be determined using the equation:

Refund=F(C, P(R), A)

where C is the customer score 208, P is the refund policies 210, A is the account data 206, and R is the reason 510. The proposed refund can be displayed via the user interface 502.

Customers with one or more qualifying accounts can elect to accept or decline the proposed refund. For instance, if Courtney wishes to request a fee refund, a qualified Wachovia employee (e.g. banker, customer service agent, etc.) can enter Courtney's identification number into the customer identification field 506 and/or one or more of her account numbers via the customer account number field 508. The fee refund determination component 302 can obtain Courtney's account data, customer score, and/or refund policies based on the data fields 504. The fee refund determination component 302 can determine a permissible fee refund based on the account data, customer score, and/or refund policies, and return a proposed refund to the user for review via the proposed refund field 512 in the user interface 502. The Wachovia employee can discuss the proposed refund with Courtney, and enter her reply via the refund disposition field 514. The fee refund determination component 302 can acquire the refund disposition, and update Courtney's account data, customer score, one or more refund policies, and/or a set of tracking data.

FIG. 6 is an example block diagram of a data store 602 illustrating the subcomponents in accordance with an aspect of the subject innovation. The data store 602 can include a plurality of data types related to customer accounts and/or a financial institution's business objectives. The data types can include but are not limited to account data 604, customer scores 606, refund policies 608, and/or tracking data 610.

The account data 604 can include a customer's account types, contact information, length of patronage, value of accounts, fees issued (e.g. late fees, overdraft fees, etc.), prior fee refund request, and so forth (e.g. data reflecting a customer's relationship with a financial institution). The customer scores 606 are essentially confidence ratings assigned to customers based on their specific customer data, such as account data 604.

The refund policies 608 can include one or more policies regarding the financial institution's fee refund procedure. For instance, the refund policies 608 can contain a policy prohibiting fee refunds for customer accounts less than 60 days old. The tracking data 610 can contain data regarding fee refunds or related information specific to a customer, branch, financial institution, market, and so forth. As discussed supra, the data store 602 can obtain the account data 604, customer score 606, refund policies 608, and/or tracking data 610 via the fee refund disposition component 302, data analytics component 402, and/or user interface component 502.

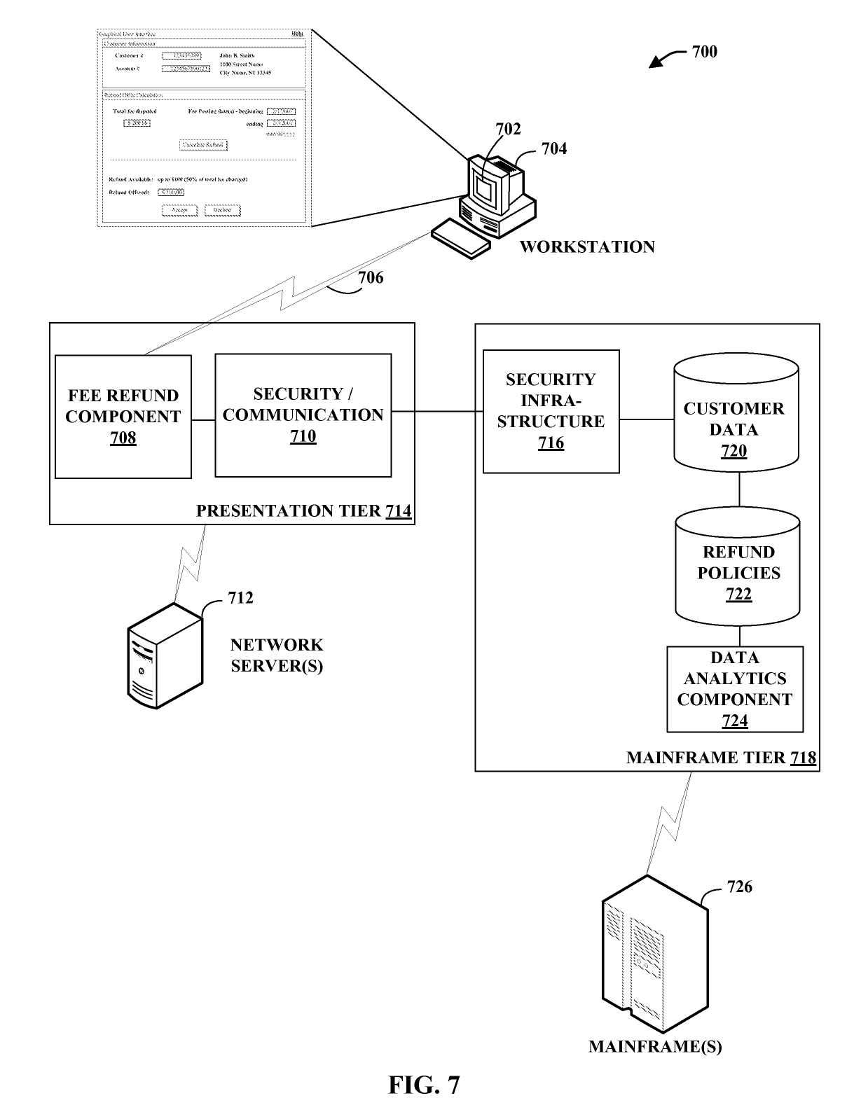

FIG. 7 illustrates an example schematic block diagram of a fee refund system 700 in accordance with an aspect of the subject innovation. The system 700 includes a front end user interface 702 executed on a computer workstation 704. Each entity of the fee refund system 700 can be remotely located with communication made across a private and/or public network 706. Administration of the front end user interface 702, a fee refund component 708, and a security/communication infrastructure 710 are managed by one or more network servers 712 of a presentation tier 714. It is to be appreciated that this architecture is but one example, and a plurality of architectures are possible within the scope of this invention.

In this example, the presentation tier 714 provides the security/communication infrastructure 710 for receiving customer data from the workstation 704 which is routed through a security infrastructure (e.g., file inspection, firewall etc.) 716 of a main frame tier 718. The customer data submissions are authenticated against a customer data database 720 of the mainframe tier 718. The mainframe tier 718 includes a refund policies database 722, and a data analytics component 724. As noted supra, the refund policies database 722 maintains data regarding policies for issuing fee refunds. The data analytics component 724 determines a customer score as a function of the customer's account data maintained in the customer data database 720. In addition, the data analytics component 724 can update the customer score maintained in the customer data database 720. The mainframe tier 718 can be managed by one or more mainframes 726.

In operation, the fee refund component 708 can facilitate query of the customer data database 720 for the customer score, and can facilitate query of the refund policies 722 for policies regarding issuing refunds. The fee refund component 708 returns an allowable fee refund to the workstation 704 via the network 706 and the front end user interface 702. A user can determine a refund disposition (e.g. accept or decline) for the proposed refund, wherein the refund disposition is entered by a banker or customer service agent via the workstation 704. The fee refund component 708 can update the customer data database 720 with the refund disposition.

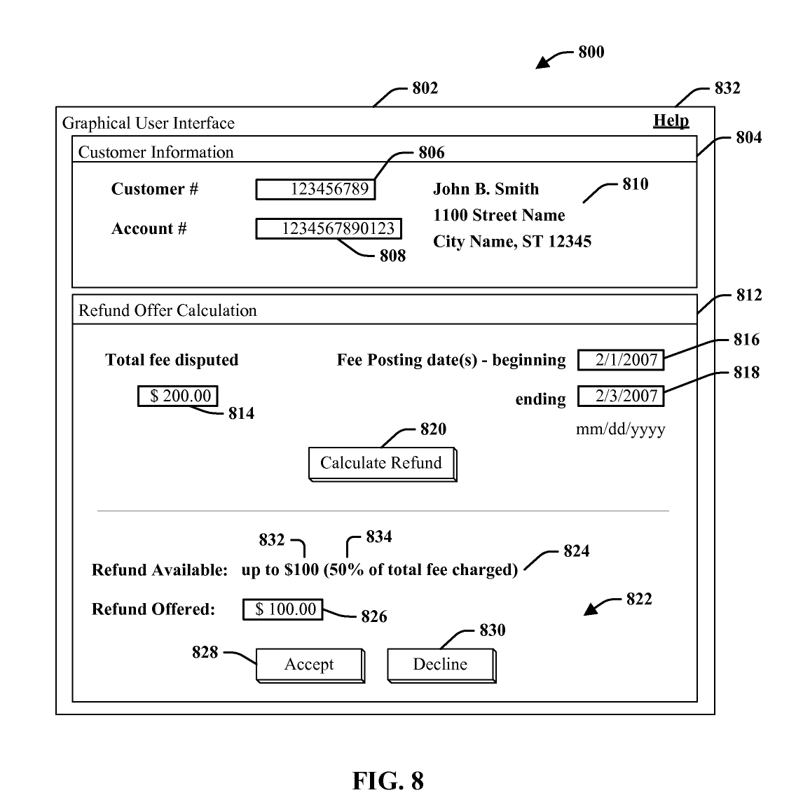

User interaction with the fee refund component 708 and the front end user interface 702 can be accomplished through a sequence of graphical user interfaces (GUI) that would be presented on the workstation 704 (see FIG. 8).

FIG. 8 illustrates an example graphical user interface (GUI) 800 for a fee refund system in accordance with one or more aspects of the subject innovation. The GUI 800 includes a home view window 802, which is depicted for the user upon logging into the fee refund system 800. The home view window 802, in an illustrative aspect, presents a fee refund offered for a given set of customer data. The home view window 802 includes a customer information section 804. The customer information section includes a customer identification number (e.g. RRN) input field 806, and an account number input field 808. Following verification of the customer identification number 806 and account number 808 the customer's name and address can be displayed in a display field 810. The display field 810 provides for an additional verification of the input data by the user.

The Fee Refund Management System 800 home view window 802 includes a refund offer calculation section 812. The refund offer calculation section 812 includes a total disputed fee input field 814, a fee posting beginning date input field 816, a fee posting ending date input field 818, and a calculate refund button 820. The user enters the appropriate information regarding a fee that the customer would like to dispute in the input fields 814, 816, and 818, respectively. As noted supra, the Fee Refund Management System 800 verifies the information (e.g. existence of the fee, the amount charged, etc.) and queries a customer data database for a customer score, subsequent to the user activating the calculate refund button 820.

The refund calculation section further includes a refund offer and disposition sub-pane 822. The sub-pane 822 includes a refund available display field 824, a refund offered field 826, an accept button 828, and a decline button 830. The refund available display field 824 is populated with a proposed refund amount 832 and a refund percentage 834. As previously discussed, the refund percentage 834 is determined mostly based on the customer score (discussed supra) and used to calculate the proposed allowable refund amount 832. Additionally, the refund offered 826 can be automatically populated with the proposed refund amount 832 and subsequently changed by the user if a different (e.g. lower) refund amount if offered. The user can offer the customer a refund less than or equal to the proposed refund amount 832. The disposition of the offer by the customer is entered into the system 800 using the accept 828 and decline 830 buttons. As mentioned previously, the customer data database is updated with the disposition of the offered refund. Additionally or alternatively, it is to be appreciated that a qualified user (e.g. banker, customer service representative, etc.) can override the proposed refund amount 832, and offer the customer a refund less than or equal to the total fee assessed. In order to override the proposed refund amount 832 the user can enter, select, or otherwise determine an override reason (not shown).

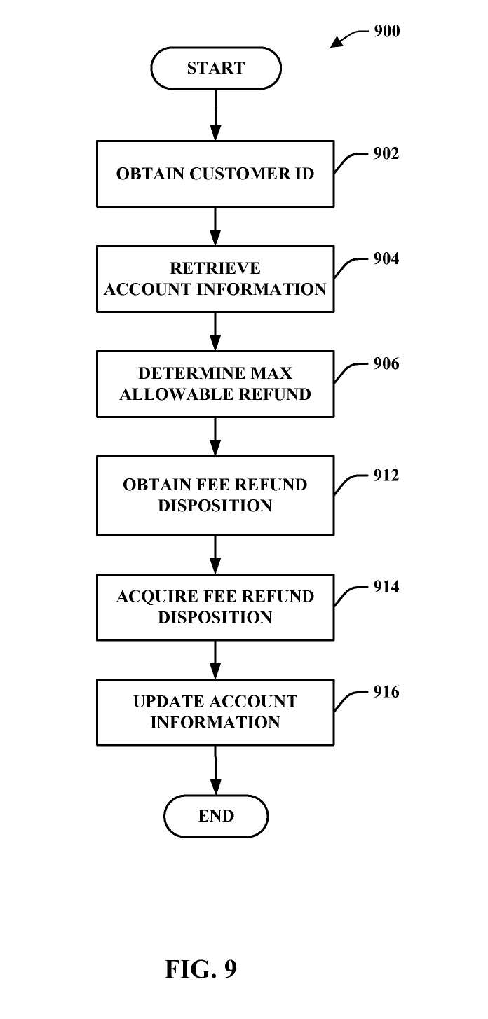

In view of the example systems described supra, a methodologies that may be implemented in accordance with the disclosed subject matter will be better appreciated with reference to the flow chart of FIG. 9. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, the illustrated blocks do not represent all possible steps, and not all illustrated blocks may be required to implement the methodologies described hereinafter.

FIG. 9 illustrates an example method of fee refund determination in accordance with one or more aspects of the subject innovation. At 902, one or more customer identifiers (e.g. customer identification number, account number, social security number, or other distinguishing characteristics) can be obtained to initiate a fee refund request. In addition, alternative data, such as a credit score or a circumstance of the fee assessment can be acquired.

At 904, the customer identifier is used to query a data store, and collect one or more customer data objects and refund policies relating to the requesting customer. The customer data can include account information and/or a customer score. As discussed previously, the account information can include account types, contact information, length of patronage, value of accounts, fees issued (e.g. late fees, overdraft fees, etc.), prior fee refund request, and so forth (e.g. data reflecting a customer's relationship with a financial institution). The customer scores are confidence ratings assigned to customers based mostly on their account information. Additionally or alternatively, a user can manually input one or more customer data objects. The refund policies can include one or more policies regarding the financial institution's policy on various fee refund request scenarios. In addition, the refund policies can include business objectives, such as a desire to retain customers.

At 906, a permissible fee refund is generated based at least in part on the customer data and/or refund policies. The permissible fee refund can be based on the type of accounts that the requesting customer has with the financial institution (e.g. savings, checking, money market, brokerage, mortgage, etc.), how long the customer has held those accounts, the value of the accounts, how many fees have been issued on those accounts and the reasons for the fees, whether the customer has requested previous fee refunds, and the financial institution's business objectives. For instance, if a customer has recently requested a fee refund for their checking account, then no permissible fee refund may be returned. As another example, if a customer is requesting a second fee refund in a certain time span, but the customer is a high value customer who has been with the financial institution for a substantial amount of time, then a fee refund can be generated based on the customer data and the refund policies, including the financial institution's business objectives. Additionally or alternatively, it is to be appreciated that the permissible refund amount can be superseded by a higher refund amount based at least in part on one or more override reasons. For instance, if an overdraft fee is incorrectly assessed against Courtney Customer's checking account, and the permissible refund generated is only 50% of the total fee assessed, then an incorrect fee assessment can be obtained as an override reason and the total fee assessed can be refunded to her account.

At 908, a disposition of the proposed fee refund is obtained. Customers with one or more qualifying accounts can elect to accept or decline the proposed refund.

At 910, the customer data and/or a set of tracking data are updated based on the customer's disposition of the proposed fee refund. For instance, if the customer accepts the proposed refund, then the refund can be applied to the customer's account and their account data can be updated to reflect the fee refund request and acceptance. In addition, the tracking data can be updated to reflect the disposition of the proposed refund for record keeping purposes, and/or future adjustment of the business objectives.

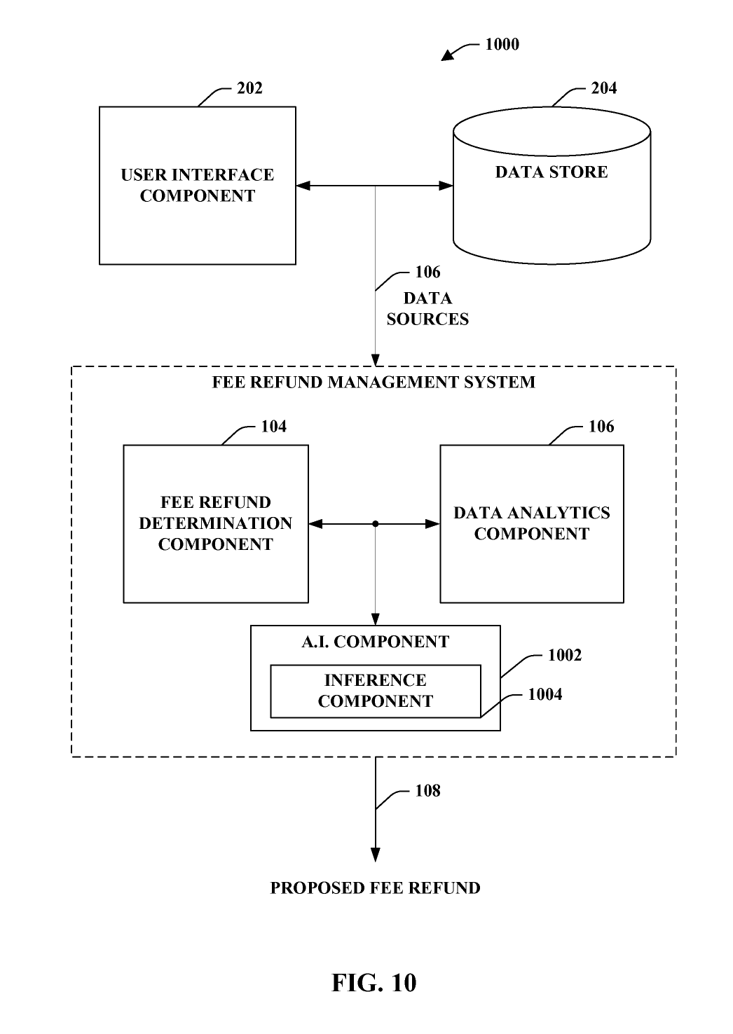

FIG. 10 illustrates a system 1000 that employs an artificial intelligence (Al) component 1002 that facilitates automating one or more features in accordance with the subject innovation. The subject innovation (e.g., in connection with inferring) can employ various Al-based schemes for carrying out various aspects thereof. For example, a process for adjusting the account data, customer scores, refund policies, and/or or tracking data can be facilitated via an automatic classifier system and process. In addition, a process for determining a customer disposition (e.g. accept or decline) regarding a proposed fee refund, or determining an optimum fee refund to propose to the customer can be facilitated via an automatic classifier system and process. Wherein, the optimum fee refund to propose can be a fee refund amount below the permissible refund amount that the customer is likely to accept.

A classifier is a function that maps an input attribute vector, x (x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed.

A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naive Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the subject innovation can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be used to automatically learn and perform a number of functions, including but not limited to determining according to a predetermined criteria when to update or refine the previously inferred schema, tighten the criteria on the inferring algorithm based upon the kind of data being processed (e.g., financial versus non-financial, personal versus non-personal, . . . ), and at what time of day to implement tighter criteria controls (e.g., in the evening when system performance would be less impacted).

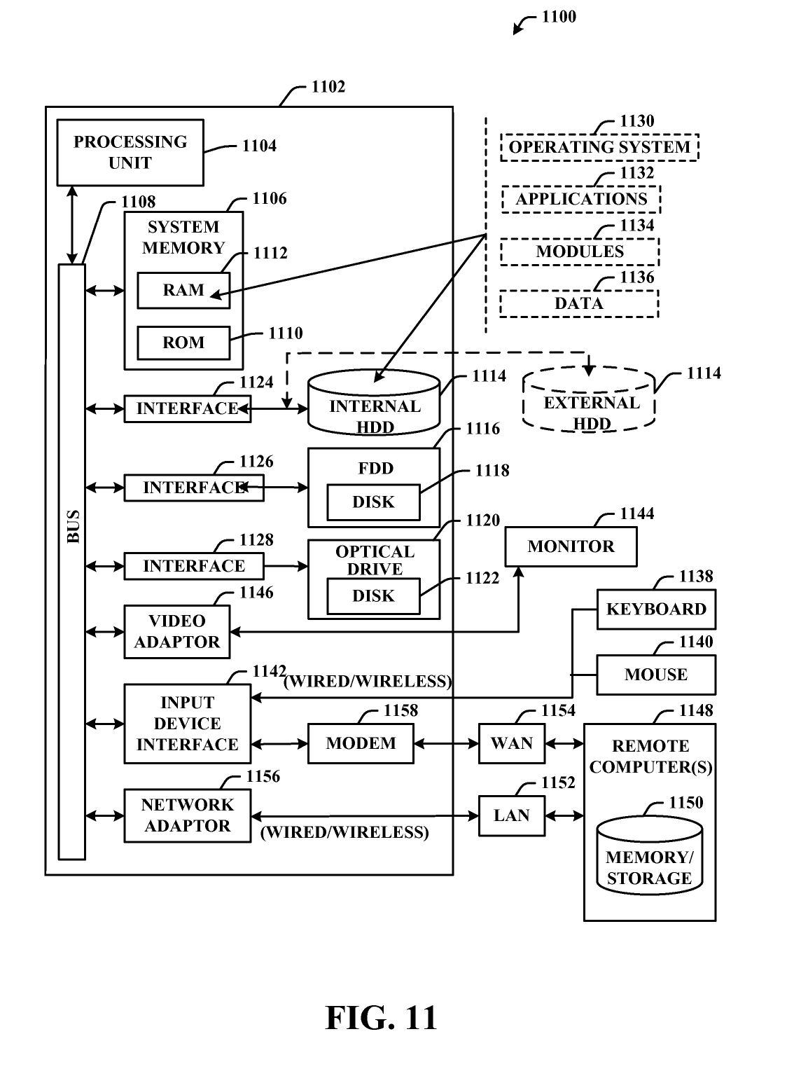

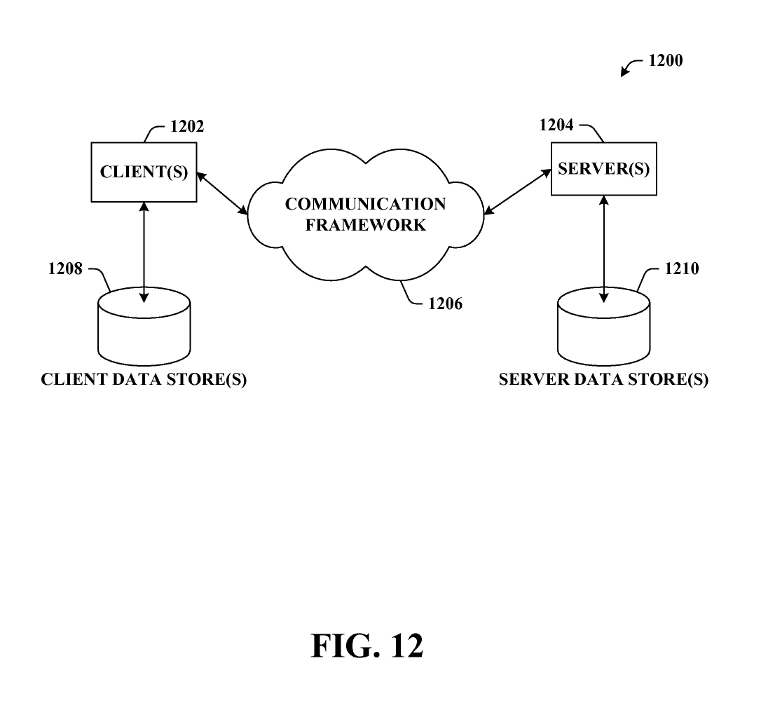

In order to provide a context for the various aspects of the disclosed subject matter, FIGS. 11 and 12 as well as the following discussion are intended to provide a brief, general description of a suitable environment in which the various aspects of the disclosed subject matter can be implemented. While the subject matter has been described above in the general context of computer-executable instructions of a program that runs on one or more computers, those skilled in the art will recognize that the subject matter described herein also can be implemented in combination with other program modules. Generally, program modules include routines, programs, components, data structures, etc. that perform particular tasks and/or implement particular abstract data types. Moreover, those skilled in the art will appreciate that the inventive methods can be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects can also be practiced in distributed computing environments where tasks are performed by remote processing devices that are linked through a communications network. However, some, if not all aspects of the claimed subject matter can be practiced on stand-alone computers. In a distributed computing environment, program modules can be located in both local and remote memory storage devices.

Referring now to FIG. 11, there is illustrated a block diagram of a computer operable to execute the disclosed architecture. In order to provide additional context for various aspects of the subject innovation, FIG. 11 and the following discussion are intended to provide a brief, general description of a suitable computing environment 1100 in which the various aspects of the innovation can be implemented. While the innovation has been described above in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer readable media. Computer readable media can be any available media that can be accessed by the computer and includes both volatile and nonvolatile media, removable and non-removable media. By way of example, and not limitation, computer readable media can comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 11, there is illustrated an example environment 1100 for implementing various aspects of the innovation that includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi processor architectures may also be employed as the processing unit 1104.

The system bus 1108 can be any of several types of bus structure that may further interconnect to a memory bus (with or without a memory controller), a peripheral bus, and a local bus using any of a variety of commercially available bus architectures. The system memory 1106 includes read only memory (ROM) 1110 and random access memory (RAM) 1112. A basic input/output system (BIOS) is stored in a non-volatile memory 1110 such as ROM, EPROM, EEPROM, which BIOS contains the basic routines that help to transfer information between elements within the computer 1102, such as during start-up. The RAM 1112 can also include a high-speed RAM such as static RAM for caching data.

The computer 1102 further includes an internal hard disk drive (HDD) 1114 (e.g., EIDE, SATA), which internal hard disk drive 1114 may also be configured for external use in a suitable chassis (not shown), a magnetic floppy disk drive (FDD) 1116, (e.g., to read from or write to a removable diskette 1118) and an optical disk drive 1120, (e.g., reading a CD-ROM disk 1122 or, to read from or write to other high capacity optical media such as the DVD). The hard disk drive 1114, magnetic disk drive 1116 and optical disk drive 1120 can be connected to the system bus 1108 by a hard disk drive interface 1124, a magnetic disk drive interface 1126 and an optical drive interface 1128, respectively. The interface 1124 for external drive implementations includes at least one or both of Universal Serial Bus (USB) and IEEE 1394 interface technologies.

The drives and their associated computer-readable media provide nonvolatile storage of data, data structures, computer-executable instructions, and so forth. For the computer 1102, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the example operating environment, and further, that any such media may contain computer-executable instructions for performing the methods of the innovation.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. It is appreciated that the innovation can be implemented with various commercially available operating systems or combinations of operating systems.

A user can enter commands and information into the computer 1102 through one or more wired/wireless input devices, e.g., a keyboard 1138 and a pointing device, such as a mouse 1140. Other input devices (not shown) may include a microphone, an IR remote control, a joystick, a game pad, a stylus pen, touch screen, or the like. These and other input devices are often connected to the processing unit 1104 through an input device interface 1142 that is coupled to the system bus 1108, but can be connected by other interfaces, such as a parallel port, an IEEE 1394 serial port, a game port, a USB port, an IR interface, etc.

A monitor 1144 or other type of display device is also connected to the system bus 1108 via an interface, such as a video adapter 1146. In addition to the monitor 1144, a computer typically includes other peripheral output devices (not shown), such as speakers, printers, etc.

The computer 1102 may operate in a networked environment using logical connections via wired and/or wireless communications to one or more remote computers, such as a remote computer(s) 1148. The remote computer(s) 1148 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory storage device 1150 is illustrated. The logical connections depicted include wired/wireless connectivity to a local area network (LAN) 1152 and/or larger networks, e.g., a wide area network (WAN) 1154. Such LAN and WAN networking environments are commonplace in offices, and companies, and facilitate enterprise-wide computer networks, such as intranets, all of which may connect to a global communication network, e.g., the Internet.

When used in a LAN networking environment, the computer 1102 is connected to the local network 1152 through a wired and/or wireless communication network interface or adapter 1156. The adaptor 1156 may facilitate wired or wireless communication to the LAN 1152, which may also include a wireless access point disposed thereon for communicating with the wireless adaptor 1156.

When used in a WAN networking environment, the computer 1102 can include a modem 1158, or is connected to a communications server on the WAN 1154, or has other means for establishing communications over the WAN 1154, such as by way of the Internet. The modem 1158, which can be internal or external and a wired or wireless device, is connected to the system bus 1108 via the serial port interface 1142. In a networked environment, program modules depicted relative to the computer 1102, or portions thereof, can be stored in the remote memory/storage device 1150. It will be appreciated that the network connections shown are exemplary and other means of establishing a communications link between the computers can be used.

The computer 1102 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

Referring now to FIG. 12, there is illustrated a schematic block diagram of an example computing environment 1200 in accordance with the subject innovation. The system 1200 includes one or more client(s) 1202. The client(s) 1202 can be hardware and/or software (e.g., threads, processes, computing devices). The client(s) 1202 can house cookie(s) and/or associated contextual information by employing the innovation, for example.

The system 1200 also includes one or more server(s) 1204. The server(s) 1204 can also be hardware and/or software (e.g., threads, processes, computing devices). The servers 1204 can house threads to perform transformations by employing the innovation, for example. One possible communication between a client 1202 and a server 1204 can be in the form of a data packet adapted to be transmitted between two or more computer processes. The data packet may include a cookie and/or associated contextual information, for example. The system 1200 includes a communication framework 1206 (e.g., a global communication network such as the Internet) that can be employed to facilitate communications between the client(s) 1202 and the server(s) 1204.

Communications can be facilitated via a wired (including optical fiber) and/or wireless technology. The client(s) 1202 are operatively connected to one or more client data store(s) 1208 that can be employed to store information local to the client(s) 1202 (e.g., cookie(s) and/or associated contextual information). Similarly, the server(s) 1204 are operatively connected to one or more server data store(s) 1210 that can be employed to store information local to the servers 1204.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A fee refund management system, comprising:
a data analytics component that determines at least one of a customer score, or a set of refund policies; and
a fee refund determination component that determines a proposed fee refund for at least one of a deposit account, an investment account, or a credit account based at least in part on at least one of the customer score or the refund policy.

2. The system of claim 1, the data analytics component determines the customer score based at least in part on a relationship between a customer and a financial institution, the relationship including at least one of the customer's account type, account balance, prior fees assessed, prior fee refund requests, or length of patronage.

3. The system of claim 1, further comprising a user interface component that exposes at least one interface that facilitates user interaction with the system.

4. The system of claim 3, the user interface component obtains at least one data field from at least one of a user or a data store, the data fields that include at least one of a customer identification field, an account number field, or a reason field.

5. The system of claim 4, the fee refund determination component verifies the data field by comparing a subset of the data fields against data maintained in a data store, and acquires at least one of the customer score or refund policies from the data store.

6. The system of claim 1, the data analytics component stores at least one of the customer score or the refund policies in a data store.

7. The system of claim 6, the data analytics component updates at least one of the customer score or refund policy maintained in the data store at a predetermined interval.

8. The system of claim 1, the fee refund component updates at least one of a customer's account data, the customer score, or the tracking data, based at least in part on a disposition of the proposed fee refund, the disposition includes at least one of an acceptance or a rejection.

9. The system of claim 1, further comprising an artificial intelligence component that facilitates automating at least one of: adjusting at least one of a set of account data, a customer score, a refund policy, or a set of tracking data, determining a customer disposition regarding a proposed fee refund, or determining an optimum fee refund to propose to the customer, wherein the optimum fee refund to propose can be a fee refund amount below the permissible refund amount that the customer is likely to accept.

10. A computer-implemented method of fee refund management, comprising:
analyzing at least one of a customer score or a set of refund policies; and
generating a proposed fee refund for at least one of a deposit account, an investment account, or a credit account based at least in part on at least one of the customer score or the refund policies.

11. The computer-implemented method of claim 10, further comprising analyzing a relationship between a customer and a financial institution to determine the customer score, wherein the relationship based at least in part on at least one of account types, account balance, prior fees assessed, prior fee refund request, or length of patronage.

12. The computer-implemented method of claim 10, further comprising obtaining a set of refund policies, wherein the set of refund policies include a financial institution's policies regarding issuing fee refunds.

13. The computer-implemented method of claim 10, further comprising capturing a user input that includes at least one data field, wherein the data field includes at least one of a customer identification field, an account number filed, or a new customer field.

14. The computer-implemented method of claim 13, further comprising verifying the data field by comparing the data field and a set of data maintained in a data store, and collecting at least one of the customer score or refund policies from the data store if the data fields are verified.

15. The computer-implemented method of claim 10, further comprising storing at least one of the customer score or the set of refund policies in a data store.

16. The computer-implemented method of claim 15, further comprising modifying at least one of the customer score or the set of refund policies maintained in the data store based at least in part on at least one of: changes to the customer score or refund policies, or a passage of time.

17. The computer-implemented method of claim 16, further comprising modifying the set of refund policies based at least in part on at least one of the tracking data, or data obtained from an external source.

18. The computer-implemented method of claim 10, further comprising updating at least one of a customer's account data, the customer score, or the tracking data based at least in part on a disposition of the proposed fee refund, wherein the disposition includes at least one of an acceptance or a rejection.

19. A fee refund management system, comprising:
means for determining at least one of a customer score, or a set of refund policies, wherein the customer score is based at least in part on a relationship between a customer and a financial institution, the relationship includes including at least one of a customer's account types, account balances, prior refunds, or length of patronage; and
means for determining a proposed fee refund for a customer account based at least in part on at least one of the customer score or the set of refund policies.

20. The system of claim 19, wherein the fee refund is for at least one of a non-sufficient funds fee, a late payment fee, or an automated teller machine fee.
